(19) United States
(12) Patent Application Publication
(10) Pub. No.: US 2026/0080866 A1
(43) Pub. Date: Mar. 19, 2026

(54) Entry Points for LLM-Powered Assistants

(71) Applicant: Google LLC, Mountain View, CA (US)

(72) Inventors: Matthew Sharifi, Kilchberg (CH); Victor Carbune, Zürich (CH)

(73) Assignee: Google LLC, Mountain View, CA (US)

(21) Appl. No.: 18/890,706

(22) Filed: Sep. 19, 2024

(51) Int. Cl. G10L 15/183; G06F 3/0482; G06F 16/242; G06N 3/0475; G10L 15/06; G10L 15/065; G10L 15/08; G10L 15/22

(52) U.S. Cl. CPC G10L 15/183; G06F 16/243; G06N 3/0475; G10L 15/063; G10L 15/065; G10L 15/22; G06F 3/0482; G10L 2015/0635; G10L 2015/088

(57) ABSTRACT

A method includes receiving a particular trigger input directed toward an assistant large language model (LLM). The particular trigger input specifying a particular functionality for the assistant LLM to undertake for processing a follow-on query from the user. The method also includes obtaining an adaptation input specifically formulated for adapting the assistant LLM to undertake the particular functionality specified by the particular trigger input. The method also includes receiving the follow-on query and providing the adaptation input for input to the assistant LLM. The method also includes processing the follow-on query to fulfill performance of an action specified by the natural language query using the adapted assistant LLM undertaking the particular functionality specified by the particular trigger input.

### TECHNICAL FIELD

This disclosure relates to entry points for LLM-powered assistants.

### BACKGROUND

Large language models are increasingly used to provide conversational experiences between users and digital assistant interfaces executing on user devices. In general, a user provides a query/prompt to the LLM in natural language that requests information and the LLM generates, based on the query/prompt, a response conveying the requested information. As LLMs are currently opening up a wide range of applications due to their powerful understanding and generation capabilities which can operate over text, image, and/or audio inputs, LLMs are becoming customized to operate and provide specific services for users.

### SUMMARY

One aspect of the disclosure provides a computer-implemented method that when executed on data processing hardware causes the data processing hardware to perform operations for using entry points for LLM-powered assistants. The operations include receiving, from a user, a particular trigger input directed toward an assistant large language model (LLM). The particular trigger input specifies a particular functionality for the assistant LLM to undertake for processing a follow-on query from the user. The operations also include obtaining an adaptation input based on the received particular trigger input. The adaptation input is specifically formulated for adapting the assistant LLM to undertake the particular functionality specified by the particular trigger input. The operations also include receiving the follow-on query form the user. The follow-on query includes a natural language query that specifies an action for the assistant LLM to perform. The operations also include providing, for input to the assistant LLM, the adaptation input specifically formulated for adapting the assistant LLM to undertake the particular functionality specified by the particular trigger input. The operations also include processing, using the adapted assistant LLM undertaking the particular functionality specified by the particular trigger input, the follow-on query to fulfill performance of the action specified by the natural language query.

Implementations of the disclosure may include one or more of the following optional features. In some implementations, receiving the particular trigger input from the user includes receiving a user input indication indicating selection of a particular user interface (UI) element displayed on a screen in communication with the data processing hardware. In these implementations, the particular UI elements may be one of at least two different UI elements displayed on the screen. Each UI element of the at least two different UI elements specifying a different respective particular functionality for the assistant LLM to undertake. In some examples, receiving the particular trigger input from the user includes receiving a hotword detection event indicating detection of a particular hotword in streaming audio captured by a microphone in communication with the data processing hardware. In these examples, the particular hotword may be one of at least two different predetermined hotwords. Each predetermined hotword of the at least two different predetermined hotwords specifies a different respective functionality for the assistant LLM to undertake.

In some implementations: the assistant LLM includes a pretrained assistant LLM having a set of pre-trained weights; obtaining the adaptation input based on the received particular trigger input includes processing the particular trigger input to identify a particular set of fine-tuned weights that map to the particular trigger input, the particular set of fine-tuned weights includes the adaptation input and are trained to adapt the assistant LLM model to undertake the particular functionality specified by the particular trigger input while the set of pretrained weights of the pretrained assistant LLM are frozen; and providing the adaptation input for input to the assistant LLM includes activating the particular set of fine-tuned weights for adapting the assistant LLM to undertake the particular functionality specified by the particular trigger input. Here, the particular set of fine-tuned weights includes one of multiple sets of fine-tuned weights. Each corresponding set of fine-tuned weights of the multiple sets of fine-tuned weights maps to a different corresponding trigger input that specifies a different corresponding functionality for the pretrained assistant LLM to undertake and is trained to adapt the pretrained assistant LLM to undertake the corresponding functionality specified by the corresponding trigger input while the set of pretrained weights of the pretrained assistant LLM are frozen. In these implementations, the pretrained assistant LLM may include a plurality of multi-head attention layers and the particular set of fine-tuned weights are implemented by one or more adaptor layers each disposed within a respective one of the plurality of multi-head attention layers of the pretrained assistant LLM or between a respective pair of the plurality of multi-head attention layers of the pretrained assistant LLM.

In some examples, obtaining the adaptation input based on the received particular trigger input includes processing the particular trigger input to identify a particular fine-tuned user prompt embedding that maps to the particular trigger input where the particular fine-tuned user prompt embedding includes the adaptation input, and providing the adaptation input for the input to the assistant LLM includes concatenating the follow-on query with the particular fine-tuned user prompt embedding that maps to the particular trigger input and providing the concatenation of the follow-on query with the particular fine-tuned prompt embedding as input to the assistant LLM. Here, when processing the follow-on query to fulfill performance of the action specified by the natural language query, the particular fine-tuned user prompt embedding is configured to guide the assistant LLM to undertake the particular functionality while parameters of the assistant LLM are held fixed. In some implementations, obtaining the adaptation input based on the received particular trigger input includes processing the particular trigger input to identify a particular natural language prefix prompt that maps to the particular trigger input where the particular natural language prefix prompt includes the adaptation input and providing the adaptation input for input to the assistant LLM includes concatenating the follow-on query with the particular natural language prefix prompt that maps to the particular trigger input and providing the concatenation of the follow-on query with the particular natural language prefix prompt as input to the assistant LLM. Here, when processing the follow-on query to fulfill performance of the action specified by the natural language query, the particular natural language prefix prompt is configured to instruct the assistant LLM to undertake the particular functionality. The assistant LLM may include a pretrained assistant LLM having a set of pre-trained weights and obtaining the adaptation input based on the received particular trigger input includes processing the particular trigger input to identify a particular set of one or more few-shot learning examples that maps to the particular trigger input where the particular set of one or more few-shot learning examples includes the adaptation input. Here, each few-shot learning example in the particular set of the one or more few-shot learning examples depicts an example query input paired with a ground-truth response of the example query input to provide in-context learning for adapting the assistant LLM to generalize to the particular functionality specified by the trigger input.

In some examples, the operations further include commencing processing of the adaptation input to adapt the assistant LLM to undertake the particular functionality prior to commencing the processing of the follow-on query using the assistant LLM. In these examples, commencing the processing of the adaptation input may include performing vector index lookups to retrieve content relevant to the particular functionality specified by the particular trigger input for use by the assistant LLM once processing of the follow-on query commences. The retrieved content includes at least one of: one or more media files that were previously accessed by the assistant LLM to fulfill a previous query when the assistant LLM was adapted to undertake the same particular functionality, one or more documents that were previously accessed by the assistant LLM to fulfill one or more previous queries when the assistant LLM was adapted to undertake the same particular functionality, or one or more applications previously accessed by the assistant LLM to fulfill one or more previous queries when the assistant LLM was adapted to undertake the same particular functionality. Here, the operations may further include, instructing an auxiliary LLM to preprocess the retrieved content and receiving preprocessed results for the retrieved content from the auxiliary LLM. Commencing the processing of the adaptation input to adapt the assistant LLM to undertake the particular functionality includes using the preprocessed results to adapt the assistant LLM to undertake the particular functionality. In these examples, commencing the processing of the adaptation input includes loading a user interface (UI) element that was previously generated by the assistant LLM when the assistant LLM was adapted to undertake the particular functionality during fulfillment of a previous query and displaying the UI element on a screen in communication with the data processing hardware. Here, processing the follow-on query to fulfill performance of the action specified by the natural language query includes interacting with the UI element displayed on the screen based on the action specified by the natural language query.

In some implementations, the operations further include processing the adaptation input using the assistant LLM and the assistant LLM processes the adaptation input while receiving the follow-on query from the user. The operations may further include generating presentation content responsive to the follow-on query based on processing the follow-on query to fulfill performance of the action and obtaining another adaptation input specifically formulated for adapting the assistant LLM to undertake another particular functionality specified by a subsequent-follow on query based on the presentation content.

Another aspect of the disclosure provides a system that includes data processing hardware and memory hardware storing instructions that when executed on the data processing hardware causes the data processing hardware to perform operations. The operations include receiving, from a user, a particular trigger input directed toward an assistant large language model (LLM). The particular trigger input specifies a particular functionality for the assistant LLM to undertake for processing a follow-on query from the user. The operations also include obtaining an adaptation input based on the received particular trigger input. The adaptation input is specifically formulated for adapting the assistant LLM to undertake the particular functionality specified by the particular trigger input. The operations also include receiving the follow-on query form the user. The follow-on query includes a natural language query that specifies an action for the assistant LLM to perform. The operations also include providing, for input to the assistant LLM, the adaptation input specifically formulated for adapting the assistant LLM to undertake the particular functionality specified by the particular trigger input. The operations also include processing, using the adapted assistant LLM undertaking the particular functionality specified by the particular trigger input, the follow-on query to fulfill performance of the action specified by the natural language query.

Implementations of the disclosure may include one or more of the following optional features. In some implementations, receiving the particular trigger input from the user includes receiving a user input indication indicating selection of a particular user interface (UI) element displayed on a screen in communication with the data processing hardware. In these implementations, the particular UI elements may be one of at least two different UI elements displayed on the screen. Each UI element of the at least two different UI elements specifying a different respective particular functionality for the assistant LLM to undertake. In some examples, receiving the particular trigger input from the user includes receiving a hotword detection event indicating detection of a particular hotword in streaming audio captured by a microphone in communication with the data processing hardware. In these examples, the particular hotword may be one of at least two different predetermined hotwords. Each predetermined hotword of the at least two different predetermined hotwords specifies a different respective functionality for the assistant LLM to undertake.

In some implementations: the assistant LLM includes a pretrained assistant LLM having a set of pre-trained weights; obtaining the adaptation input based on the received particular trigger input includes processing the particular trigger input to identify a particular set of fine-tuned weights that map to the particular trigger input, the particular set of fine-tuned weights includes the adaptation input and are trained to adapt the assistant LLM model to undertake the particular functionality specified by the particular trigger input while the set of pretrained weights of the pretrained assistant LLM are frozen; and providing the adaptation input for input to the assistant LLM includes activating the particular set of fine-tuned weights for adapting the assistant LLM to undertake the particular functionality specified by the particular trigger input. Here, the particular set of fine-tuned weights includes one of multiple sets of fine-tuned weights. Each corresponding set of fine-tuned weights of the multiple sets of fine-tuned weights maps to a different corresponding trigger input that specifies a different corresponding functionality for the pretrained assistant LLM to undertake and is trained to adapt the pretrained assistant LLM to undertake the corresponding functionality specified by the corresponding trigger input while the set of pretrained weights of the pretrained assistant LLM are frozen. In these implementations, the pretrained assistant LLM may include a plurality of multi-head attention layers and the particular set of fine-tuned weights are implemented by one or more adaptor layers each disposed within a respective one of the plurality of multi-head attention layers of the pretrained assistant LLM or between a respective pair of the plurality of multi-head attention layers of the pretrained assistant LLM.

In some examples, obtaining the adaptation input based on the received particular trigger input includes processing the particular trigger input to identify a particular fine-tuned user prompt embedding that maps to the particular trigger input where the particular fine-tuned user prompt embedding includes the adaptation input, and providing the adaptation input for the input to the assistant LLM includes concatenating the follow-on query with the particular fine-tuned user prompt embedding that maps to the particular trigger input and providing the concatenation of the follow-on query with the particular fine-tuned prompt embedding as input to the assistant LLM. Here, when processing the follow-on query to fulfill performance of the action specified by the natural language query, the particular fine-tuned user prompt embedding is configured to guide the assistant LLM to undertake the particular functionality while parameters of the assistant LLM are held fixed. In some implementations, obtaining the adaptation input based on the received particular trigger input includes processing the particular trigger input to identify a particular natural language prefix prompt that maps to the particular trigger input where the particular natural language prefix prompt includes the adaptation input and providing the adaptation input for input to the assistant LLM includes concatenating the follow-on query with the particular natural language prefix prompt that maps to the particular trigger input and providing the concatenation of the follow-on query with the particular natural language prefix prompt as input to the assistant LLM. Here, when processing the follow-on query to fulfill performance of the action specified by the natural language query, the particular natural language prefix prompt is configured to instruct the assistant LLM to undertake the particular functionality. The assistant LLM may include a pretrained assistant LLM having a set of pre-trained weights and obtaining the adaptation input based on the received particular trigger input includes processing the particular trigger input to identify a particular set of one or more few-shot learning examples that maps to the particular trigger input where the particular set of one or more few-shot learning examples includes the adaptation input. Here, each few-shot learning example in the particular set of the one or more few-shot learning examples depicts an example query input paired with a ground-truth response of the example query input to provide in-context learning for adapting the assistant LLM to generalize to the particular functionality specified by the trigger input.

In some examples, the operations further include commencing processing of the adaptation input to adapt the assistant LLM to undertake the particular functionality prior to commencing the processing of the follow-on query using the assistant LLM. In these examples, commencing the processing of the adaptation input may include performing vector index lookups to retrieve content relevant to the particular functionality specified by the particular trigger input for use by the assistant LLM once processing of the follow-on query commences. The retrieved content includes at least one of: one or more media files that were previously accessed by the assistant LLM to fulfill a previous query when the assistant LLM was adapted to undertake the same particular functionality, one or more documents that were previously accessed by the assistant LLM to fulfill one or more previous queries when the assistant LLM was adapted to undertake the same particular functionality, or one or more applications previously accessed by the assistant LLM to fulfill one or more previous queries when the assistant LLM was adapted to undertake the same particular functionality. Here, the operations may further include, instructing an auxiliary LLM to preprocess the retrieved content and receiving preprocessed results for the retrieved content from the auxiliary LLM. Commencing the processing of the adaptation input to adapt the assistant LLM to undertake the particular functionality includes using the preprocessed results to adapt the assistant LLM to undertake the particular functionality. In these examples, commencing the processing of the adaptation input includes loading a user interface (UI) element that was previously generated by the assistant LLM when the assistant LLM was adapted to undertake the particular functionality during fulfillment of a previous query and displaying the UI element on a screen in communication with the data processing hardware. Here, processing the follow-on query to fulfill performance of the action specified by the natural language query includes interacting with the UI element displayed on the screen based on the action specified by the natural language query.

In some implementations, the operations further include processing the adaptation input using the assistant LLM and the assistant LLM processes the adaptation input while receiving the follow-on query from the user. The operations may further include generating presentation content responsive to the follow-on query based on processing the follow-on query to fulfill performance of the action and obtaining another adaptation input specifically formulated for adapting the assistant LLM to undertake another particular functionality specified by a subsequent-follow on query based on the presentation content.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for adapting an assistant interface to interact with external large language models (LLMs) to perform action on behalf of a user.

FIG. 2 is a schematic view of an example process for adapting the assistant LLM to interoperate with an external LLM.

FIG. 3 is a schematic view of an example assistant LLM.

FIG. 4 is a flowchart of an example arrangement of operations for using entry points for LLM-powered assistants.

FIG. 5 is a schematic view of an example computing device that may be used to implement the systems and methods described herein.

Like reference symbols in the various drawings indicate like elements.

### DETAILED DESCRIPTION

Humans may engage in human-to-computer dialogs with interactive software applications referred to as “chatbots,” “voice bots,” “automated assistants,” “interactive personal assistants,” “intelligent personal assistants,” “conversational agents,” etc. via a variety of computing devices. As one example, these chatbots may correspond to a machine learning model or a combination of different machine learning models, and may be utilized to perform various tasks on behalf of users. Chatbots adopting large language models (LLMs) are currently opening up a wide range of applications due to their powerful understanding and generation capabilities which can operate over text, image, and/or audio inputs. These models are also being extended with actuation capabilities via integration mechanisms with various service providers.

As LLMs become increasingly common, it is evident that not only will users have their own personalized assistant LLMs, but different entities will develop LLMs as an important mechanism to offer services to end users. For example, a business entity may offer an LLM for users to interact with the business. While existing assistant LLMs allow for users to easily trigger the assistant (e.g., by selecting a button and/or speaking a hotword), the existing assistant LLMs are not particularly flexible when there are many different assistants or external LLMs available with a very broad or open-ended set of capabilities. Consequently, users oftentimes switch between different assistant LLMs or construct long and elaborate prompts to elicit certain behaviors from the assistant LLM. Switching between different assistant LLMs and constructing elaborate prompts is cumbersome for users to interact with the different functionalities provided by the various LLMs.

To that end, implementations herein are directed towards an assistant LLM that uses entry points. In particular, the assistant LLM receives, from a user, a particular trigger directed toward the assistant LLM. The particular trigger input may specify a particular functionality for the assistant LLM to undertake for processing a follow-on query from the user. As will become apparent, the particular trigger input may include a hotword detection event and/or a user input indication indicating a selection of a particular user interface (UI) element. The assistant LLM obtains an adaptation input based on the received particular trigger input. The assistant LLM may obtain the adaptation input from one or more external LLMs and/or the assistant LLM itself. The adaptation input is specifically formulated for adapting the assistant LLM to undertake the particular functionality specified by the particular trigger input. The assistant LLM receives, from the user, the follow-on query. The follow-on query includes a natural language query specifying an action for the assistant LLM to perform. The follow-on query may be a spoken input or a textual input. The adaptation input is provided as input to the assistant LLM to adapt the assistant LLM to undertake the particular functionality specified by the particular trigger input. The adapted assistant LLM undertakes the particular functionality specified by the particular trigger input by processing the follow-on query to fulfill performance of the action specified by the natural language query.

As such, the assistant LLM allows the user to seamlessly interact with the assistant LLM and one or more external LLMs. This enables the user to efficiently switch between different LLMs and leverage the functionalities provided by each of the LLMs. The efficient switching between different LLMs reduces user visible latency and allows the user to issue shorter prompts/queries to perform particular functionalities.

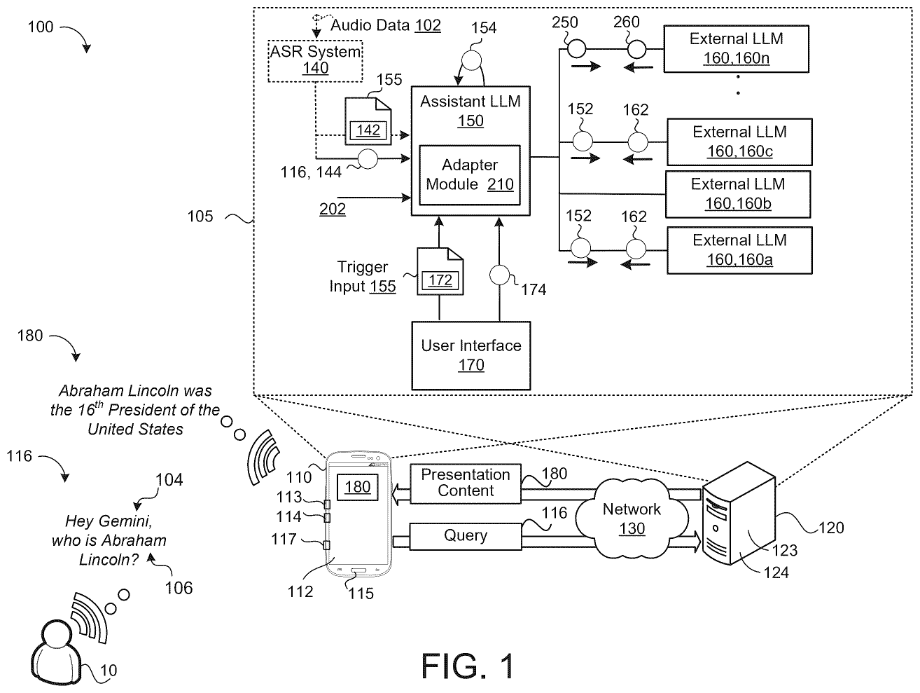

FIG. 1 illustrates an example system 100 including an LLM adaptation system 105 that adapts an assistant large language model (LLM) 150 using an adaptation input 260 to perform actions for the assistant LLM 150 to perform on behalf of a user 10 associated with the assistant LLM 150. As will become apparent, the assistant LLM 150 obtains the adaptation input 260 based on a particular trigger input 155 which may include a hotword detection event indication 142 and/or a user input indication 172. Generally, the user 10 inputs, via a user device 110, a natural language query 116 to the assistant LLM 150 specifying a particular action the user 10 wants the assistant LLM 150 to perform on behalf of the user 10, and the assistant LLM 150 selects one or more external LLMs 160, 160a-n for the assistant LLM 150 to interact with to fulfill performance of the action. Here, the assistant LLM 150 may process the natural language query 116 (or a transcription 144 of the natural language query 116) by performing query interpretation to ascertain the particular action to be performed. In some examples, the transcription 144 is a textual representation of a follow-on query 106. Fulfillment of the particular action may require performance of multiple portions, or sub-actions/tasks, that collectively define the particular action. In some examples, the natural language query 116 includes a hotword 104 and the follow-on query 106. The follow-on query 106 may be spoken by the user 10 or provided as a textual input. The follow-on query specifies an action for the assistant LLM 150 to perform. For example, the query 116 may include “Hey Gemini, who is Abraham Lincoln” where “Hey Gemini” corresponds to the hotword 104 and “who is Abraham Lincoln” corresponds to the follow-on query 106. As such, the assistant LLM 150 may select one or more of the external LLMs 160 to fulfill the performance of a corresponding portion of the action specified by the natural language query 116 input to the assistant LLM 150. For each corresponding external LLM 160 selected by the assistant LLM 150, the assistant LLM 150 issues, for input to the corresponding external LLM 160, a respective prompt 152 specifically formulated for the corresponding external LLM 160 to fulfill performance of the corresponding portion of the action, and receives, from the corresponding external LLM 160, corresponding response content 162 that conveys details regarding performance of the corresponding portion of the action fulfilled by the corresponding external LLM 160. As will become apparent, the assistant LLM 150 may generate the prompt 152 that is specifically formulated based on the particular trigger input 155 (e.g., hotword detection event indication 142 and/or user input indication 172). That is, each particular trigger input 155 may be mapped to one or more of the external LLMs 160 (or the assistant LLM 150) and to a set of fine-tuned weights, a particular fine-tuned user prompt embedding, a particular natural language prefix prompt, a set of one or more few-shot learning examples, and/or a soft prompt. Notably, the assistant LLM 150 may include the selected external LLM such that the assistant LLM 150 generates the prompt 152 specifically formulated based on the particular trigger input 155 and uses the prompt 152 to obtain the adaptation input 260 for adapting the assistant LLM to undertake the particular functionality specified by the particular trigger input 155.

The assistant LLM 150 may facilitate, with or without involving input from the user 10, multiple interactions with corresponding external LLM 160 until the corresponding portion of the action is fulfilled. Based on the corresponding response content 162 received from each corresponding external LLM 160, the assistant LLM 150 is configured to provide, for output from the user device 110, presentation content 180. The user device 110 may audibly output, from an audio output device (e.g., acoustic speaker) 117, the presentation content 180 as synthesized speech. Additionally or alternatively, the user device 110 may display, on a screen 112 in communication with the user device 110, graphics, text, and/or other visual information that conveys the details of the presentation content 180.

The system includes the user device 110, a remote computing system 120, and a network 130. The user device 110 includes data processing hardware 113 and memory hardware 114. The user device 110 may include, or be in communication with, and audio capture device 115 (e.g., an array of one or more microphones) for converting utterances of natural language queries 116 spoken by the user 10 into corresponding audio data 102 (e.g., electrical signals or digital data). In lieu of spoken input, the user may input a textual representation of the natural language query 116 via a user interface 170 executing on the user device 110. In scenarios when the user 10 speaks a natural language query captured by the microphone 115 of the user device 110, an automated speech recognition (ASR) system 140 executing on the user device 110 or the remote computing system 120 may process the corresponding audio data 102 to generate a transcription of the query 116. Here, the transcription conveys the natural language query 116 as a textual representation for input to the assistant LLM 150. The ASR system 140 may implemented any number and/or type(s) of past, current, or future speech recognition systems, models and/or methods including, but not limited to, and end-to-end speech recognition model, such as streaming speech recognition models having recurrent neural network-transducer (RNN-T) model architecture, a hidden Markov model, and acoustic model, a pronunciation model, a language model, and/or a naïve Bayes classifier.

In some implementations, the ASR system 140 incudes a hotword model or keyword model that detects a presence of a hotword (i.e., keyword) or a warm word. Notably, the ASR system 140 may detect the presence of the hotword or the warm word before transcribing any of the audio data 102 into text. The ASR system 140 may require that the hotword precede a spoken command before the ASR system 140 processes the spoken command that follows the hotword. Similarly, warm words may correspond to particular actions that the ASR system 140 may detect without requiring the hotword before the warm word. For example, the ASR system 140 may detect the warm word of “next song” without requiring the user 10 to first speak the hotword of “Hey Google.” In some examples, the assistant LLM 150 receives the particular trigger input 155 from the user 10 by receiving the hotword detection event indication 142 of a particular hotword (or warmword) in streaming audio 102 captured by a microphone in communication with the data processing hardware 113, 123. Thus, the hotword detection event indication 142 may be received from a same device (e.g., user device 110 or remote computing system 120) that the assistant LLM 150 is executing on, or a different device. For instance, the assistant LLM 150 may execute on the remote computing system 120 and the assistant LLM 150 may receive the hotword detection event indication 142 from the ASR system 140 executing on the user device 110.

The particular hotword may be one of at least two different predetermined hotwords. Each predetermined hotword of the at least two different predetermined hotwords specifying a different respective functionality for the assistant LLM 150 to undertake. For example, the at least two different predetermined hotwords may include a first predetermined hotword of “Hey Google” and a second predetermined hotword of “Hey Gemini.” In this example, the first predetermined hotword may specify a functionality of “function as an information engine” for the assistant LLM 150 to undertake when processing the follow-on query and the second predetermined hotword may specify another functionality of “function as a friendly assistant” for the assistant LLM 150 to undertake when processing the follow-on query. Thus, as will become apparent, the assistant LLM 150 may generate different presentation content 180 for the same follow-on query based on the specified functionality of the hotword.

In some implementations, the assistant LLM 150 receives the particular trigger input 155 from the user 10 by receiving the user input indication 172 indicating a selection of a particular user interface (UI) element displayed on the screen 112 of the user device 110 in communication with the data processing hardware 113, 123. The particular UI element may be one of at least two different UI elements displayed on the screen 112 of the user device 110. Each UI element of the at least two different UI elements specifying a different respective particular functionality for the assistant LLM 150 to undertake. For example, the at least two different UI elements may include a first UI element associated with a first functionality and a second UI element associated with a second functionality. More specifically, the first UI element may be associated with the functionality of “function as an information engine” for the assistant LLM 150 to undertake when processing the follow-on query and the second UI element may specify another functionality of “function as a friendly assistant” for the assistant LLM 150 to undertake when processing the follow-on query. Additionally or alternatively, the first UI element may be associated with a first external LLM 160 while the second UI element may be associated with a second external LLM 160.

The user device 110 may be any computing device capable of communicating with the remote computing system 120 through the network 130. The user device 110 includes, but is not limited to, desktop computing devices and mobile computing devices, such as laptops, tablets, smart phones, smart speakers/displays, digital assistant devices, smart appliances, internet-of-things (IoT) devices, infotainment systems, vehicle infotainment systems, and wearable computing devices (e.g., headsets, smart glasses, and/or watches).

The remote computing system 120 may be a distributed system (e.g., a cloud computing environment) having scalable elastic resources. The resources include computing resources 123 (e.g., data processing hardware) and/or storage resources 124 (e.g., memory hardware). Additionally or alternatively, the remote computing system 120 may be a centralized system. The network 130 may be wired, wireless, or a combination thereof, and may include private networks and/or public networks, such as the Internet.

With continued reference to FIG. 1, the LLM adaptation system 105 includes the ASR system 140, the assistant LLM 150, the plurality of external LLMs 160, and the user interface 170. The ASR system 140 may be optional or only leveraged when the user 10 prefers spoken input of natural language queries 116 as opposed to typed input of natural language queries 116. In some implementations, the LLM adaptation system 105 executes on both the data processing hardware 113 of the user device 110 and the data processing hardware 123 of the remote computing system 120. For instance, one or more components of the LLM adaptation system 105 may execute on the data processing hardware 113 of the user device 110 while one or more other components of the LLM adaptation system 105 may execute on the remote computing system 120. While not shown, the external LLMs 160 may execute on different remote computing systems depending on the service providers operating the external LLMs 160. As such, the assistant LLM 150 may interact with different external LLMs 160 of the LLM adaptation system 105 that execute across a diverse set of remote computing systems operated by different service providers.

A particular entity may develop and offer its own version of an external LLM 160 that is backed by a particular cloud service provider. For example, a business or application developer may develop an external LLM 160 for interacting with a search engine application while another business or application developer may develop another external LLM 160 for interacting with a chatbot application. Thus, a first external LLM 160 offered by a first entity may be contracted through a first cloud service provider while a second external LLM 160 offered by a second entity may be contracted through a second cloud service provider. In this example, the first external LLM 160 may include a first pre-trained LLM (e.g., Google Cloud LLM) customized for the first entity that includes a far greater number of LLM parameters (e.g., 540 billion parameters) than a number of LLM parameters (e.g., 11 billion parameters) of the second external LLM that includes a second pre-trained LLM (e.g., Ascenty LLM) customized for the second entity. Here, the first entity may provide training samples that include training prompts paired with corresponding ground-truth responses to create the first external LLM 160 as a customized version of the first pre-trained LLM. Similarly, the second entity may provide its own training samples that include training prompts paired with corresponding ground-truth responses to create the second external LLM 160 as a customized version of the second pre-trained LLM.

The training, or more specifically, the customization process for creating an external LLM 160 may lead to each entity having different LLM capabilities. Moreover, each LLM may have multiple capabilities whereby, depending on the prompt 152, the LLM performs a particular one of the multiple capabilities. For instance, the customization process may include various levels that serve to customize the resulting external LLM 160 with distinct capabilities. While the number of LLM parameters, available plug-ins, and/or application programming interfaces (APIs) offered by each particular cloud service provider may constrain the LLM capabilities of the resulting external LLM 160, various training techniques, such as fine-tuning, prompt-tuning, and/or reinforcement learning (RL) fine-tuning may provide additional level of customization of the LLM capabilities offered by the external LLM 160. For instance, an entity may use few-shot learning to create a customized version of an existing pre-trained LLM offered by a cloud service provider. On the other hand, prompt-tuning may be implemented to learn how to create soft prompts that guide an existing pre-trained LLM offered by the cloud service provider to provide responses customized for the entity while parameters of the pre-trained LLM are held fixed. That is, an entity may fine-tune (e.g., few-shot examples, soft prompts via prompt-tuning, and/or separate adapter weights) inputs external to an existing pre-trained LLM that is already capable of being utilized in conducting more generalized conversation and/or for fine-tuning prompts input to the existing pre-trained LLM without fine-tuning the pre-trained LLM.

In some implementations, the assistant LLM 150 is personalized for the user 10. The assistant LLM 150 may function as a personal chatbot capable of having dialog conversations with the user 10 in natural language and performing tasks/actions on the user's behalf. In some examples, the assistant LLM 150 includes an instance of Bard, LaMDA, BERT, Meena, ChatGPT, or any other previously trained LLM. These previously trained LLMs have been previously trained on enormous amounts of diverse data and are capable of engaging in corresponding conversations with users in a natural and intuitive manner. However, these LLMs have a plurality of machine learning (ML) layers and hundreds of millions to hundreds of billions of ML parameters. Accordingly, in implementations where the assistant LLM 150 is an instance of a previously-trained LLM fine-tuned locally at the user device 110, the previously trained LLM that is obtained and fine-tuned to provide the assistant LLM 150 personalized for the user 10 may be a sparse version of the previously trained LLM. In contrast, in implementations where the assistant LLM 150 is an instance of the previously trained LLM fine-tuned remotely from the client device, the previously trained LLM that is obtained and fine-tuned to provide the assistant LLM 150 may be a dense version of the previously trained LLM. The sparse version of the previously trained LLM may have fewer ML layers, fewer ML parameters, masked weights, and/or other sparse aspects to reduce the size of the previously trained LLM due to various hardware constraints and/or software constraints at the user device 110 compared to the virtually limitless resources of the remote computing system 120.

The assistant LLM 150 allows unstructured free-form natural language input that conveys the details of the actions/tasks to be performed but does not define any corresponding dialog state map (e.g., does not define any dialog states or any dialog state transitions). For example, the prompt 116 may request the assistant LLM 150 to book a flight and a hotel to a particular city for specified dates. Alternatively, the prompt 116 may request the assistant LLM 150 to provide information on a particular topic. In yet another example, the prompt 116 may request the assistant LLM 150 to instruct another device to perform an action, such as requesting a smart light to turn on or off. In some examples, in response to receiving the query 116 as the unstructured free-form natural language input, the assistant LLM 150 interacts with an external LLM 160 that is capable of performing an action/task specified by the query 116 by structuring a prompt for input to the external LLM 160 that causes the external LLM to perform the action/task on behalf of the user 10. The external LLM 160 may return response content 162 to the assistant LLM 150 that conveys the details of the action task/performed and the assistant LLM 150 may provide presentation content 180 for output from the user device 110 that serves as a response to the query 116 by conveying information associated with the response content 162 returned from one or more external LLMs 160. The assistant LLM 150 may determine the presentation content 180 based on the response content 162 provided by each external LLM 160 that performed a corresponding portion of the action on behalf of the user 10. Further, the presentation content 180 may include, for example, a corresponding result of one or more tasks performed by external LLMs 160, a corresponding summary of the corresponding tasks, and/or other content.

In other examples, in response to receiving the query 116 as the unstructured free-form natural language input, the assistant LLM 150 may perform actions, or portions of actions, on behalf of the user 10 without the need to interact with any external LLMs 160, That is, the assistant LLM 150 may generate the presentation content 180, or portions of the presentation content 180, without interacting with any of the external LLMs 160 when the assistant LLM 150 is capable of performing the action/task specified by the query 116. In some implementations, the assistant LLM 150 includes a conventional virtual digital assistant that does not utilize LLM functionality but may use heuristic/rules to interoperate with the external LLMs 160 for performing actions on behalf of the user 10.

The external LLMs 160 available for the assistant LLM 150 to interact with for performing actions on behalf of the user 10 may be adapted based on a configuration input 202 received by the assistant LLM 150. Each configuration input 202 may specify one or more external LLMs 160 to add to a preferred group of external LLMs for the assistant LLM 150 to interact with to fulfill actions on behalf of the user 10. Here, the configuration input 202 may cause the assistant LLM 150 to send an adaptation request 250 to an external LLM 160 requesting the external LLM 160 to interact with the assistant LLM 150. The external LLM 160, or entity associated therewith, may return an adaptation input 260 to the assistant LLM 150 that provides details for the assistant LLM 150 to best adapt when interoperating with the external LLM 160 to most effectively achieve the intent of the user 10. In some examples, when the assistant LLM 150 is capable of performing the action itself, the assistant LLM 150 may obtain the configuration input 202 and adaptation input 260 from itself. The assistant LLM 150 may include, or communicate with, an adapter module 210 that receives the adaptation input 260 for use in configuring the assistant LLM 150 to adapt for interoperating with each external LLM 160.

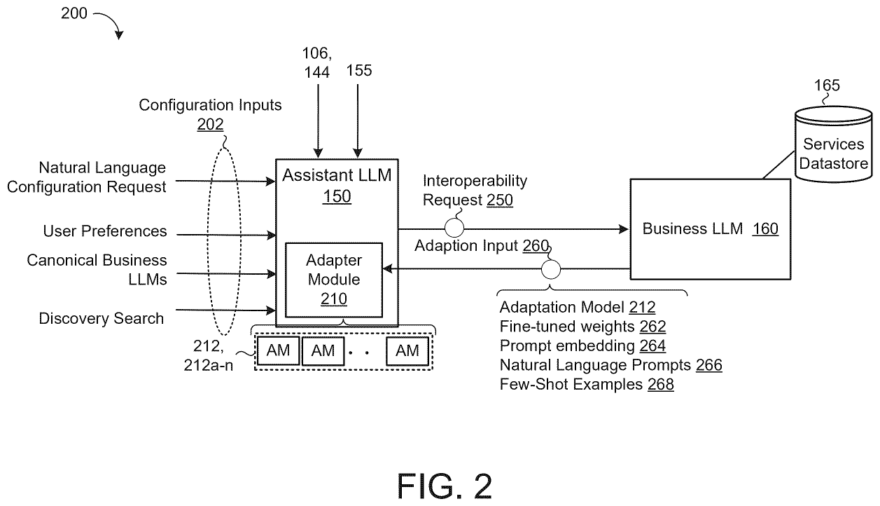

FIG. 2 shows a schematic view 200 of an example adaptation process performed by the assistant LLM 150 for adapting the assistant LLM 150 for interoperability with an example external LLM 160. The assistant LLM 150 may perform the adaptation process for each external LLM 160 the assistant LLM 150 wants to operate with. In some examples, the configuration input 202 received by the assistant LLM 150 includes a natural language configuration request input by the user 10 that explicitly specifies one or more candidate external LLMs 160 to add to a preferred group of external LLMs 160. For instance, the natural language configuration request may state, “I'd like to order from eat.ch most of my dishes, except Indian ones for which I'd like to use smood.ch.” Here, the assistant LLM 150 may be configured to translate the natural language configuration request into a configuration by sending adaptation request 250 to respective external LLMs 160 offered by eat.ch and smood.ch, whereby the external LLMs 160 may return respective adaptation inputs 260.

In some additional examples, a configuration input 202 received by the assistant LLM 150 includes user preferences that may indicate services the user 10 prefers to use, services used by the user ascertained from user history, user feedback, and/or applications installed on the user device. For instance, the assistant LLM 150 may learn that the user 10 always books flights on Delta Airlines and collects reward points for Delta Airlines via a dedicated credit card. Moreover, a configuration input 202 may indicate a discovery search from the user 10 that requests the assistant LLM 150 to search for external LLMs 160 having service capabilities specified by the discovery search. Here, the external LLM 160 may have memory-augmentation with an external datastore of services 165 that the user 10 may query or search by feeding a discovery prompt to the assistant LLM 150.

In some additional examples, a configuration input 202 indicates canonical external LLMs 160 associated with external LLMs 160 that are popular across a population of users for performing common tasks. A canonical external LLM 160 may be input to the preferred group of external LLM candidates for the assistant LLM 150 automatically if the canonical external LLM 160 is associated with an entity already authorized by the user. If the user 10 has not already authorized the entity associated with a canonical external LLM 160 specified in the configuration input 202, the assistant LLM 150 may suggest the canonical external LLM 160 for inclusion in the preferred group of external LLM candidates, whereby the user 10 may explicitly select the canonical external LLMs 160 for inclusion in the preferred group via a checkbox displayed by the user interface 170. By the same notion, the user 10 may remove any external LLM from the preferred group of external LLM candidates at any time, e.g., by unselecting an associated checkbox displayed by the user interface for the external LLM 160 the user 10 wants to remove. The canonical external LLMs 160 deemed available may depend on a geographical region the user 10 is located. For instance, an external LLM 160 offered by a food delivery service that only operates in the United States would not be available for a user residing in the United Kingdom.

With continued reference to FIG. 2, in some implementations, the adaptation input 260 returned from the external LLM 160 (or obtained from the assistant LLM 150) showcases the LLM capabilities of the external LLM 160 to inform the assistant LLM 150 how to best adapt for when interoperating with the external LLM 160. The adaptation input 260 may include an adaptation model 212, prompt examples, natural language constraints, a size of the external LLM 160 (e.g., number of parameters), and/or capabilities of the external LLM 160. The adaptation model 212 may be published by the external LLM 160 and be specific to the external LLM 160 for use by the assistant LLM 150 for generating prompts specifically formatted for interacting with the corresponding external LLM 160. Here, an entity associated with the external LLM 160 may train the respective adaptation model 212 to structure prompts from natural language for interacting with the external LLM 160. In some examples, the adapter module 210 stores a plurality of adaptation models 212, 212a-n each associated with a respective external LLM 160 the assistant LLM 150 is configured to operate with. In these examples, and described in greater detail below, the assistant LLM 150 may activate the respective adaptation model 212 associated with each external LLM 160 the assistant LLM 150 has selected to interoperate with to fulfill an action on behalf of the user 10. An adaptation model 212 previously trained by the entity may be fine-tuned by the assistant LLM 150 based on positive/negative interactions from the user regarding response content returned from the external LLM 160 from previous prompts structured from the adaptation model 212. In some implementations, the assistant LLM 150 includes an encoder-decoder architecture whereby an encoder network is configured to encode the natural language query 116 into an encoded representation and a decoder network is configured to decode the encoded representation into a resulting prompt specially formatted for a particular external LLM 160 to fulfill performed of a corresponding portion of an action specified by the natural language query 116. In these implementations, the adapter module 210 may activate the respective adaptation model 212 associated with a corresponding external LLM 160 such that the activated adaptation model 212 includes a prefix to the decoder network of the assistant LLM 150. The adaptation model 212 may serve as a sub-model to the assistant LLM 150, whereby the adaptation model 212 biases how prompts for interacting with the corresponding external LLM 160 are structured.

In some scenarios, the adapter module 210 uses prompt examples included in the adaptation input 260 that convey a prompt structure advertised by the external LLM 160. Here, the adapter module 210 may use the prompt examples to adapt the assistant LLM 150 to convert a natural language query 116 input to the assistant LLM 150 into a respective soft prompt specifically formulated to include the prompt structure conveyed by the prompt examples. A soft prompt may include a numerical representation (e.g., vector) that may be provided as input to the external LLM 160 instead of a natural language prompt. The prompt examples included in the adaptation input 260 may include few-shot examples operative to fine-tune the external LLM 160 to perform specific tasks or provide response content 162 with a particular domain.

The adapter module 210 may additionally or alternatively use natural language constraints included in the adaptation input 260 for paraphrasing natural language queries 116 into a format suitable for prompting the external LLM 160. Here, the natural language constraints provide constraints on how the assistant LLM 150 and the external LLM 160 communicate via natural language. As such, the natural language constraints may permit that adapter module 210 to convert a natural language query into a respective natural language prompt that permits the assistant LLM 150 to communicate with the corresponding external LLM 160 via natural language. For instance, the external LLM 160 may require that the natural language prompt includes terms spelled a certain way or content has to be narrowed from what was included in the original natural language query 116. In some examples, the assistant LLM 150 and/or adapter module 210 uses the natural language constraints to generate a template for converting the natural language queries input by the user to the assistant LLM 150 into natural language prompts specifically formatted for the external LLM 160.

The adapter module 210 may receive the adaptation input 260 for use in configuring the assistant LLM 150 for interacting with the external LLM 160. Notably, the adapter module 210 configures the assistant LLM 150 to convert natural language queries input to the assistant LLM 150 into corresponding prompts specifically formatted for the external LLM 160 to fulfill performance of corresponding portions of the action specified by the natural language queries. Based on the rationale that the external LLMs 160 include a vast and diverse set of LLM capabilities and are provided by different cloud service providers, the assistant LLM 150 must access the adapter module 210 to ascertain how to interoperate with each external LLM 160 on a case-by-case basis. For instance, for two different external LLMs 160 each capable of booking flights, a prompt generated by the assistant LLM 150 for invoking one of the external LLMs for booking a flight may not be suitable for invoking the other external LLM 160 to book the same flight. Stated differently, the assistant LLM 150 accesses the adapter module 210 for adapting the assistant LLM 150 to structure prompts specific to the external LLM 160 the assistant LLM 150 is interoperating with at a given instance.

In some scenarios, the assistant LLM 150 or one of the external LLMs 160 is capable of performing multiple functionalities. For example, one of the LLMs may be able to perform as an information engine or a friendly assistant depending on the respective prompt 152 received by the LLM. That is, a first prompt 152 may cause the LLM to perform the functionality of the information engine while a second prompt 152 may cause the LLM to perform the functionality of the friendly assistant. As will become apparent, the assistant LLM 150 may obtain the adaptation input 260 based on the particular trigger input 155 and adapt the assistant LLM 150 to perform the particular functionality specified by the particular trigger input 155 when processing the follow-on query 106. For instance, the hotword event detection indication 142 corresponding to the hotword of “Hey Google” may cause assistant LLM 150 to adapt to undertake the information engine functionality while the hotword event detection indication 142 corresponding to the hotword of “Hey Gemini” may cause the assistant LLM 150 to adapt to undertake the friendly assistant functionality. Notably, the different functionalities undertaken by the assistant LLM 150 may case different results or outputs when processing the same follow-on query 106.

In some implementations, the assistant LLM 150 includes a pretrained assistant LLM having a set of pre-trained weights. The adaptation input 260 may include the adaptation model 212, one or more natural language prompts 266, one or more soft prompts, fine-tuned model weights (e.g., low-rank adaptation (LoRA)) 262, previous query/responses between the user 10 and the assistant LLM 150 when the assistant LLM 150 was adapted to undertake the same particular functionality, and/or relevant UI features, documents, content, etc. To that end, the assistant LLM 150 may obtain the adaptation input 260 based on the received particular trigger input 155 by processing the particular trigger input 155 to identify a particular set of fine-tuned weights 262 that map to the particular trigger input 155. Here, the particular set of fine-tuned weights 262 includes the adaptation input 260 are trained to adapt the assistant LLM 150 to undertake the particular functionality specified by the particular trigger input 155 while the set of pretrained weights of the pretrained assistant LLM 150 are frozen. Moreover, the particular set of fine-tuned weights 262 includes one of multiple sets of fine-tuned weights 262. Each set of fine-tuned weights 262 of the multiple sets of fine-tuned weights 262 maps to a different corresponding trigger input 155 that specifies a different corresponding functionality for the pretrained assistant LLM 150 to undertake and is trained to adapt the pretrained assistant LLM 150 to undertake the corresponding functionality specified by the corresponding trigger input 155 while the set of pretrained weights of the pretrained assistant LLM 150 are frozen. Thus, providing the adaptation input 260 for input to the assistant LLM includes activating the particular set of fine-tuned weights 262 for adapting the assistant LLM 150 to undertake the particular functionality specified by the particular trigger input 155.

For example, the multiple sets of fine-tuned weights 262 may include a first set of fine-tuned weights 262 and a second set of fine-tuned weights 262. Here, the first set of fine-tuned weights 262 may be mapped to a trigger input 155 of the hotword 104 “Hey Google” and is trained to adapt the pretrained assistant LLM 150 to undertake a corresponding functionality of a information engine when processing the follow-on query 106. Moreover, the second set of fine-tuned weights 262 may be mapped to a trigger input 155 of the hotword 104 of “Hey Gemini” and is trained to adapt the pretrained assistant LLM to undertake a corresponding functionality of a friendly assistant when processing the follow-on query 106.

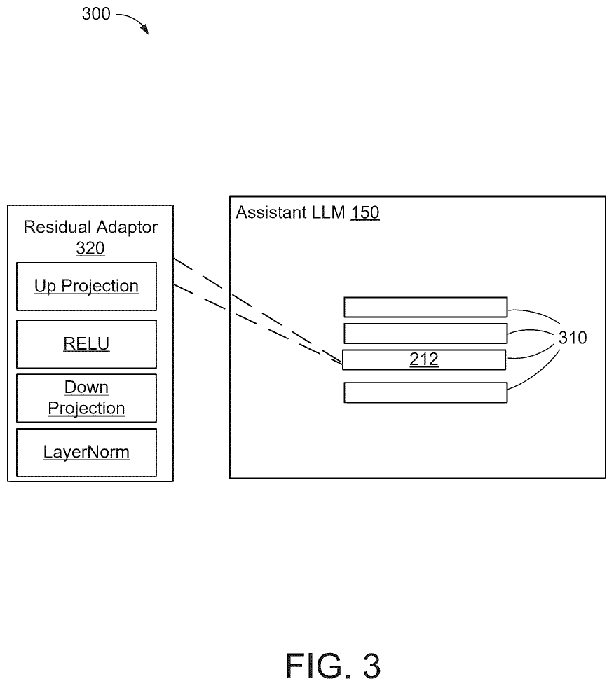

FIG. 3 shows a schematic view 300 of an example assistant LLM 150. In some examples, the pretrained assistant LLM 150 includes a plurality of multi-head attention layers 310 (e.g., conformer or transformer layers) and the particular set of fine-tuned weights 262 (FIG. 2) are implemented by one or more adaptor layers 320 each disposed within a respective one of the plurality of multi-head attention layers 310 of the pretrained assistant LLM 150 or between a respective pair of the plurality of multi-head attention layers 310 (not shown) of the pretrained assistant LLM 150. The plurality of multi-head attention layers 310 may be included in the encoder when the assistant LLM 150 includes the encoder-decoder architecture and in the decoder when the assistant LLM 150 includes the decoder-only architecture. That is, the sub-model (i.e., adaptation model) 212 may be disposed between a respective pair of plurality of multi-head attention layer 310 (not shown) or within one or more of the plurality of multi-head attention layers 310 as shown in FIG. 3. Each residual adaptor 320 may start with a layer normalization applied to the inputs of the assistant LLM, followed by a feed-forward layer with down-projection to dimension db (a bottleneck dimension), a non-linear (RELU), and another feed-forward layer with up-projection to the original input dimension di. In some implementations, all weights of the residual adaptor 320 are randomly initialized. In a specific example, each adaptation model 212 includes 17 residual adaptor layers 320, each of which is added between a layer of the encoder. Further, the bottleneck de may be set at 64 while all weights of the residual adaptor 320 are randomly initialized.

Residual adaptor layers 320 provide several benefits for implementations of the adaptation models 212. For example, residual adaptor layers 320 are easily added to the encoder, allowing for various adaptation models 212 to easily be interchanged as necessary. Further, an adaptation model 212 can easily be muted/disabled by setting the residual factor to zero (i.e., removing the adaptation model 212 and allowing the assistant LLM 150 to operate in an unbiased manner). The size of the adaptation model 212, when implemented as a residual adaptor layer 320, can be controlled by a bottle neck dimension (e.g., db) depending on the task/use-case (i.e., depending on the functionality specified by the particular trigger input 155 (FIG. 1)). Further, controlling the bottleneck dimension is internal to the adaptation model 212, allowing for pre-compiled and optimized execution graph for fast inference while being able to replace a tensor shape dynamically.

Referring back to FIG. 2, in some implementations, obtaining the adaptation input 260 based on the received particular trigger input 155 includes processing the particular trigger input 155 to identify a particular fine-tuned user prompt embedding 264 that maps to the particular trigger input 155 whereby the adaptation input 260 includes the particular fine-tuned user prompt embedding. In these examples, providing the adaptation input 260 for input to the assistant LLM 150 includes concatenating the follow-on query 106 with the particular fine-tuned prompt embedding 264 as input to the assistant LLM 150. Here, when processing the follow-on query 106 to fulfill the performance of the action specified by the natural language query, the particular fine-tuned user prompt embedding 264 is configured to guide the assistant LLM 150 to undertake the particular functionality while parameters of the assistant LLM 150 are held fixed. For example, a first fine-tuned user prompt embedding 264 may be mapped to the particular trigger input 155 of the hotword 104 “Hey Google” while a second fine-tuned user prompt embedding 264 may be mapped to the particular trigger input 155 of the hotword “Hey Gemini.” Here, the first fine-tuned user prompt embedding 264 may be configured to guide the assistant LLM 150 to undertake the information engine functionality when processing the follow-on query 106 and the second fine-tuned user prompt embedding 264 may be configured to guide the assistant LLM 150 to undertake the friendly assistant functionality when processing the follow-on query 106. Moreover, the assistant LLM 150 may concatenate the follow-on query with the particular fine-tuned user prompt embedding 264 and provide the concatenation as input to the assistant LLM 150 as the respective prompt 152.

In other implementations, obtaining the adaptation input 260 based on the received particular trigger input 155 includes processing the particular trigger input 155 to identify a particular natural language prefix prompt 266 that maps to the particular trigger input 155 whereby the adaptation input 260 includes the particular natural language prefix prompt 266. In these implementations, providing the adaptation input 260 for input to the assistant LLM 150 includes concatenating the follow-on query 106 with the particular natural language prefix prompt 266 that maps to the particular trigger input 155 and providing the concatenation of the follow-on query 106 with the particular natural language prefix prompt 266 as input to the assistant LLM 150. Here, when processing the follow-on query 106 to fulfill performance of the action specified by the natural language query, the particular natural language prefix prompt 266 is configured to instruct the assistant LLM 150 to undertake the particular functionality. For example, a first particular natural language prefix prompt 266 may be mapped to the particular trigger input 155 of the hotword 104 “Hey Google” while a second particular natural language prefix prompt 266 may be mapped to the particular trigger input 155 of the hotword “Hey Gemini.” Here, the first particular natural language prefix prompt 266 may be configured to guide the assistant LLM 150 to undertake the information engine functionality when processing the follow-on query 106 and the second particular natural language prefix prompt 266 may be configured to instruct the assistant LLM 150 to undertake the friendly assistant functionality when processing the follow-on query 106. Moreover, the assistant LLM 150 may concatenate the follow-on query 106 with the particular natural language prompt 266 and provide the concatenation as input to the assistant LLM 150 as the respective prompt 152. For instance, the assistant LLM 150 may generate a first concatenation of “I want you to function as an information engine, what is the typical weather like this month?” or a second concatenation of “I want you to function as a friendly assistant, what is the typical weather like this month?” Here, the “what is the typical weather like this month?” represents the follow-on query 106 and “I want you to function as an information engine” and “I want you to function as a friendly assistant”” represent natural language prefix prompts 266.

In some examples, obtaining the adaptation input 260 based on the received particular trigger input 155 includes processing the particular trigger input 155 to identify a particular set of one or more few-shot learning examples 288 that maps to the particular trigger input 155 whereby the adaptation input 260 includes the particular set of one or more few-shot learning examples 288. Each few-shot learning example 288 in the particular set of the one or more few-shot learning examples 288 depicts an example query input paired with a ground-truth response of the example query input to provide in-context learning for adapting the assistant LLM 150 to generalize to the particular functionality specified by the trigger input 155. Thus, the particular set of one or more few-shot learning examples 268 serve as examples that the assistant LLM 150 may reference when processing the follow-on query 106.

Referring back to FIG. 1, prior to commencing the processing of the follow-on query using the assistant LLM 150, the assistant LLM 150 may commence processing of the adaptation input 260 to adapt the assistant LLM 150 to undertake the particular functionality. Notably, the assistant LLM 150 may process the adaptation input 260 prior to adapting the assistant LLM 150 such that the assistant LLM 150 processes the adaptation input 260 while receiving the follow-on query 106 from the user 10. In some implementations, the assistant LLM 150 commences the processing of the adaptation input 260 by performing vector index loops to retrieve content 154 relevant to the particular functionality specified by the particular trigger input 155 for use by the assistant LLM 150 once processing of the follow-on query 106 commences. Advantageously, by retrieving the content 154 prior to commencing the processing of the follow-on query 106, the assistant LLM 150 may reduce the amount of time it takes (e.g., latency) to provide the presentation content 180. The content 154 retrieved by the assistant LLM 150 may include one or more media files that were previously accessed by the assistant LLM 150, one or more documents that were previously accessed by the assistant LLM 150, or one or more applications previously accessed by the assistant LLM 150. In short, the content 154 retrieved by the assistant LLM 150 includes content 154 previously accessed by the assistant LLM 150 to fulfill one or more previous queries when the assistant LLM was adapted to undertake the same or particular functionality as the current query 116. In one example, the query 116 may include a hotword and/or warm word of “Hey Spotify” whereby the content 154 retrieved by the assistant LLM 150 includes songs recently played by the user 10 and/or favorite songs of the user such that the assistant LLM 150 prefills the content 154 into the prompt 152. In another example, the query 116 may include a hotword and/or warm word of “Hey Work Assistant” whereby the content 154 retrieved by the assistant LLM 150 includes work-related emails and work-related documents. In contrast, a hotword and/or warm word of “Hey Personal Assistant” may cause the content 154 to include personal emails and personal documents. In short, the assistant LLM 150 may retrieve content 154 associated with the particular functionality of the particular trigger input 155 based on prior queries 116.

In some implementations, the assistant LLM 150 instructs an auxiliary LLM to preprocess and/or summarize the retrieved content 154 and receives preprocessed results for the retrieved content 154 from the auxiliary LLM. Here, the assistant LLM 150 commences the processing of the adaptation input 260 to adapt the assistant LLM 150 to undertake the particular functionality by using the preprocessed results to adapt the assistant LLM 150 to undertake the particular functionality. Thus, the assistant LLM 150 may use the retrieved content 154 and/or the preprocessed results to adapt the assistant LLM 150 to undertake to perform the particular functionality.

In some configurations, the assistant LLM 150 processes the adaptation input 260 by loading a user interface element 174 that was previously generated by the assistant LLM 150 when the assistant LLM 150 was adapted to undertake the particular functionality during fulfilment of a previous query and displays the UI element 274 on the screen 112 of the user device 110. Here, processing the follow-on query 105 to fulfill performance of the action specified by the natural language query 116 includes interacting with the UI element 174 displayed on the screen 112 based on the action specified by the natural language query. For example, for a prior query preceded by the assistant LLM 150 may have displayed the UI element 174 of a song playback interface or a visual dialog interface and interacted with the displayed UI element 174 by, for example, selecting a button on the song playback interface to skip to the next song or insert text into the visual dialog interface. Accordingly, when the assistant LLM 150 receives a similar query to the prior query, the assistant LLM 150 may load the UI element 174 previously generated by the assistant LLM 150 based on the particular trigger input 155 and before processing the follow-on query 106. Thus, the UI element 174 may be preloaded or cached such that when the assistant LLM 150 processes the follow-on query 106 the assistant LLM 150 may interact with the displayed UI element 174. For example, the assistant LLM 150 may anticipate that the follow-on query 106 that follows “Hey Spotify” will interact with the song playback interface and display the song playback interface before processing the follow-on query 116. Thereafter, the assistant LLM 150 may interact with the song playback interface (e.g., selecting the next song button or the previous song button) based on processing of the follow-on query 106. In another example, the assistant LLM 150 may anticipate that the follow-on query 106 that follows “Send text to” will interact with the visual dialog interface and display the visual dialog interface before processing the follow-on query 116. hereafter, the assistant LLM 150 may interact with the visual dialog interface (e.g., insert text into a text box that corresponds to a message spoken by the user) based on processing the follow-on query 116.

With continued reference to FIG. 1, for each corresponding external LLM 160 among the one or more external LLMs 160 selected by the assistant LLM 150, the assistant LLM 150 may access the adapter module 210 to structure the natural language query 116 into a respective prompt 152 specifically formulated for the corresponding external LLM 160 (or the assistant LLM 15) to fulfill performance of the corresponding portion of the action. In one example, the adapter module 210 has knowledge to feed natural language prompts to the first external LLM 160 based on the natural language constraints and/or prompt examples included in the adaptation input 260 (FIG. 2) provided from the first external LLM 160 when configuring the first external LLM 160 for interoperability with the assistant LLM 150. Accordingly, the assistant LLM 150 may access the adapter module 210 to convert the natural language query 116 into a respective natural language prompt 152 to cause the first external LLM 160 to fulfill performance of the corresponding portion of the action. In this example, the adapter module 210 has knowledge to feed soft prompts to the third external LLM 160 based on the prompt examples included in the adaptation input 260 provided from the third external LLM 160. Accordingly, the assistant LLM 150 may access the adapter module 210 to convert the natural language query 116 into a respective soft prompt 152 or natural language prompt 152 specifically formulated to include a prompt structure advertised by the third external LLM 160. The soft prompt 152 may include a numerical representation (e.g., vectors) to provide as input to the third external LLM 160c.

After issuing the respective prompt 152 to each corresponding external LLM 160 among the one or more external LLMs 160 and/or the assistant LLM 150 selected by the assistant LLM 150, the assistant LLM 150 receives, from each corresponding external LLM 160, corresponding response content 162 conveying details regarding performance of the corresponding portion of the action. Based on the corresponding response content 162 received from each corresponding external LLM 160 of the selected one or more external LLMs 160, the assistant LLM 150 uses the user interface to provide, for output from the user device 110, presentation content 180 for the user 10 that serves as a response to the natural language query 116 initially input by the user 10 that serves as a response to the natural language query 116 initially input by the user 10 to the assistant LLM 150. The assistant LLM 150 may generate the presentation content 180 based on all the response content 162 received. In some scenarios, the assistant LLM 150 refines or filters the response content 162 to provide presentation content 180 personalized for the user 10. In these scenarios, the assistant LLM 150 refines or filters the response content 162 to provide presentation content 180 personalized for the user 10. In these scenarios, the assistant LLM 160 may have knowledge of user preferences or past interaction between the user 10 and the assistant LLM 150.

The user interface 170 may audibly output the presentation content 180 as a synthesized speech representation conveying the details of the action performed responsive to the natural language query 116. Here, the user interface 170 may access a text-to-speech (TTS) system (not shown) that converts a textual representation of the presentation content 180 output from the assistant LLM 150 into synthesized speech representation. The TTS system is non-limiting and may include a TTS model and vocoder. Continuing with the example, the user interface 170 may provide the synthesized speech representation of the presentation content 180 for audible output from an acoustic speaker 118 of the user device 110. Additionally or alternatively, the assistant LLM 150 may provide visual or graphical representations of the presentation 180 for output from the user device 110 by displaying text and/or graphics on the screen of the user device 112. In some examples, the visual or graphical representation of the presentation content 180 are provided for output to supplement the synthesized speech representation of the presentation content 180.

After providing the presentation content 180, the assistant LLM 180 may determine whether or not fulfillment of the action was successful based on user feedback. In some examples, the assistant LLM 150 receives user feedback indicating that the user 10 performs actions unrelated to the previously input natural language query 116. Here, the assistant LLM 150 can make inference that the user 10 is satisfied with the presentation content and label the interaction between the assistant LLM 150 and each of the one or more corresponding external LLMs selected to perform the corresponding portions of the action as being successful. In some examples, the assistant LLM 150 stores each successful interaction instance as a positive example that include any combination of the natural language query 116 that was input to the assistant LLM 150, the external LLMs 160 selected to fulfill the corresponding portions of the action, the respective prompts 152 created and issued to the external LLMs 160, the response content 162, and the presentation content 180.

In the example shown, the user speaks the natural language query 116 of “Hey Gemini, who is Abraham Lincoln?” that includes the hotword 104 of “Hey Gemini” and the follow-on query 106 of “who is Abraham Lincoln?” Here, the assistant LLM 150 receives the particular trigger input 155 by receiving hotword detection event indication 142 from the ASR system 140 that processes the natural language query 116 to detect the hotword 104 of “Hey Gemini” from the natural language query 116. The assistant LLM 150 obtains the adaptation input 260 specifically formulated for adapting the assistant LLM 150 to undertake the particular functionality specified by the particular hotword 104. In this example, the particular trigger input 155 (e.g., the hotword detection event indication 142) may indicate that the hotword 104 of “Hey Gemini” maps to the particular functionality of a friendly assistant. The assistant LLM 150 may obtain the adaptation input 260 from one or more of the external LLMs 160 and/or the assistant LLM 150 itself. The adaptation input 260 may include one or more of the particular set of fine-tuned weights 262, the particular fine-tuned user prompt embedding 264, the particular natural language prefix prompt 266, the particular set of one or more few-shot learning examples 268, and/or the particular soft prompt each of which adapts the assistant LLM 150 to perform the functionality of the friendly assistant specified by the particular trigger input 155.

Thereafter, the LLM adaptation system 105 may adapt the assistant LLM 150 on the adaptation input 260 whereby the adapted assistant LLM 150 processes the follow-on query 106 (e.g., the textual input of the follow-on query 106 provided by the user 10 or the transcription 144 of the follow-on query 106 from the ASR system 140) to generate presentation content 180. For instance, adapting the assistant LLM 150 may include concatenating the follow-on query 106 after the particular natural language prefix prompt 266 of “I want you to function as a friendly assistant.” As such, the assistant LLM 150 (or one of the external LLMs 160) may process the concatenation of “I want you to function as a friendly assistant, who was Abraham Lincoln?” and generate response content 162. Based on the response content 162, the assistant LLM 150 generates the presentation content 180 of “Abraham Lincoln was the 16^{th} President of the United States.” Notably, since the particular trigger input 155 in this example specifies the friendly assistant functionality, the presentation content 180 includes a concise explanation of who Abraham Lincoln was. In contrast, if the functionality specified by the particular trigger input 155 was an information engine functionality, the presentation content 180 would include a more extensive explanation of who Abraham Lincoln was due to the specified information engine as opposed to the friendly assistant functionality.

In some implementations, the assistant LLM 150 obtains another adaptation input 260 from one of the external LLMs 160 (or the assistant LLM 150) based on the presentation content 180. Thus, the other adaptation input 260 is specifically formulated to adapt the assistant LLM 150 to undertake another particular functionality specified by a subsequent follow-on query 106. For instance, in the example shown, the assistant LLM 150 may obtain an adaptation input 260 specifically formulated to adapt the assistant LLM 150 to undertake another particular functionality, such as an information engine functionality, specified by a subsequent follow-on query 106. That is, responsive to the presentation content 180, the user 10 may then speak the subsequent follow-on query 106 of “can you tell me more about Abraham Lincoln?” Here, the assistant LLM 150 may anticipate this subsequent follow-on query 106 that requests the assistant LLM 150 to function as an information engine (in contrast to the friendly assistant initially specified by the particular trigger input 155). As such, after outputting the presentation content 180, the assistant LLM 150 may adapt to function as the information engine in anticipation of the user 10 asking for more information regarding Abraham Lincoln. To that end, the assistant LLM 150 may switch to the functionality of information engine when processing the subsequent follow-on query 106 to generate presentation content 180 based on the subsequent follow-on query 106.

Advantageously, the assistant LLM 150 may tailor a respective prompt 152 based on a particular external LLM 160 selected to perform the action specified by the follow-on query 106. Additionally or alternatively, the assistant LLM 150 may tailer the respective prompt 106 based on the particular trigger input 155 (e.g., hotword detection event indication 142 and/or user input indication 172) such that the selected external LLM 160 (or the assistant LLM 150) undertakes the particular functionality mapped to the particular trigger input 155. As such, the assistant LLM 150 allows users to seamlessly interact with multiple external LLMs 160 such that the assistant LLM 150 is adapted to perform the specific functionality mapped to the particular trigger input 155 provided by the user 10.

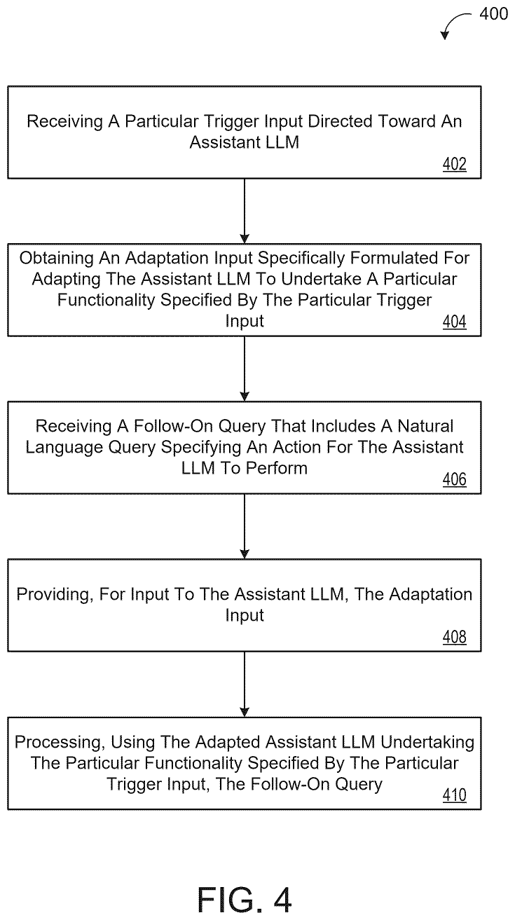

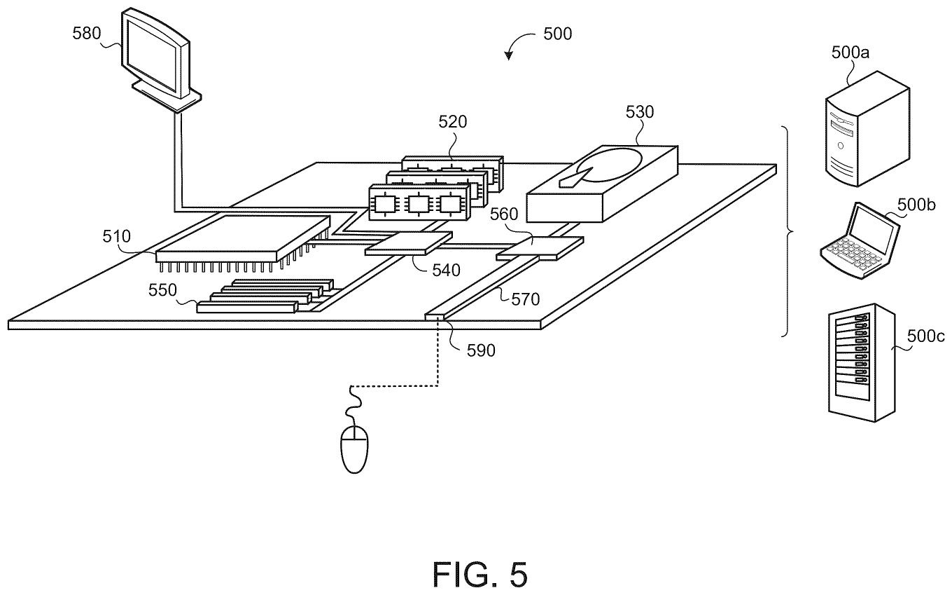

FIG. 4 illustrates a flowchart of an example flowchart of operations for a computer-implemented method 400 of using entry points for LLM-powered assistants. The method 400 may execute on data processing hardware 510 (FIG. 5) using instructions stored on memory hardware 520 (FIG. 5) that may reside on the user device 110 and/or the remote computing system 120 of FIG. 1 each corresponding to a computing device 500 (FIG. 5).

At operation 402, the method 400 includes receiving, from a user 10, a particular trigger input 155 directed toward an assistant large language model (LLM) 150. The particular trigger input 155 specifies a particular functionality for the assistant LLM 150 to undertake for processing a follow-on query 106 from the user 10. At operation 404, the method 400 includes obtaining an adaptation input 260 based on the received particular trigger input 155. The adaptation input 260 is specifically formulated for adapting the assistant LLM 150 to undertake the particular functionality specified by the particular trigger input 155. At operation 406, the method 400 includes receiving the follow-on query 106 from the user 10. The follow-on query 106 includes a natural language query that specifies an action for the assistant LLM 150 to perform. At operation 408, the method 400 includes providing, for input to the assistant LLM 150, the adaptation input 260 specifically formulated for adapting the assistant LLM 150 to undertake the particular functionality specified by the particular trigger input 155. At operation 410, the method 400 includes processing, using the adapted assistant LLM 150 undertaking the particular functionality specified by the particular trigger input 155, the follow-on query 106 to fulfill performance of the action specified by the natural language query.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system) The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks, The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving, from a user, a particular trigger input directed toward an assistant large language model (LLM), the particular trigger input specifying a particular functionality for the assistant LLM to undertake for processing a follow-on query from the user;
based on the received particular trigger input, obtaining an adaptation input specifically formulated for adapting the assistant LLM to undertake the particular functionality specified by the particular trigger input;
receiving, from the user, the follow-on query, the follow-on query comprising a natural language query specifying an action for the assistant LLM to perform;
providing, for input to the assistant LLM, the adaptation input specifically formulated for adapting the assistant LLM to undertake the particular functionality specified by the particular trigger input; and
processing, using the adapted assistant LLM undertaking the particular functionality specified by the particular trigger input, the follow-on query to fulfill performance of the action specified by the natural language query.

2. The computer-implemented method of claim 1, wherein receiving the particular trigger input from the user comprises receiving a user input indication indicating selection of a particular user interface (UI) element displayed on a screen in communication with the data processing hardware.

3. The computer-implemented method of claim 2, wherein the particular UI element is one of at least two different UI elements displayed on the screen, each UI element of the at least two different UI elements specifying a different respective particular functionality for the assistant LLM to undertake.

4. The computer-implemented method of claim 1, wherein receiving the particular trigger input from the user comprises receiving a hotword detection event indication indicating detection of a particular hotword in streaming audio captured by a microphone in communication with the data processing hardware.

5. The computer-implemented method of claim 4, wherein the particular hotword is one of at least two different predetermined hotwords, each predetermined hotword of the at least two different predetermined hotwords specifying a different respective functionality for the assistant LLM to undertake.

6. The computer-implemented method of claim 1, wherein:
the assistant LLM comprises a pretrained assistant LLM having a set of pre-trained weights;
obtaining the adaptation input based on the received particular trigger input comprises processing the particular trigger input to identify a particular set of fine-tuned weights that map to the particular trigger input, the particular set of fine-tuned weights comprising the adaptation input and trained to adapt the assistant LLM model to undertake the particular functionality specified by the particular trigger input while the set of pretrained weights of the pretrained assistant LLM are frozen; and
providing the adaptation input for input to the assistant LLM comprises activating the particular set of fine-tuned weights for adapting the assistant LLM to undertake the particular functionality specified by the particular trigger input.

7. The computer-implemented method of claim 6, wherein the particular set of fine-tuned weights comprises one of multiple sets of fine-tuned weights, each corresponding set of fine-tuned weights of the multiple sets of fine-tuned weights:
maps to a different corresponding trigger input that specifies a different corresponding functionality for the pretrained assistant LLM to undertake; and
trained to adapt the pretrained assistant LLM to undertake the corresponding functionality specified by the corresponding trigger input while the set of pretrained weights of the pretrained assistant LLM are frozen.

8. The computer-implemented method of claim 6, wherein:
the pretrained assistant LLM comprises a plurality of multi-head attention layers; and
the particular set of fine-tuned weights are implemented by one or more adaptor layers each disposed within a respective one of the plurality of multi-head attention layers of the pretrained assistant LLM or between a respective pair of the plurality of multi-head attention layers of the pretrained assistant LLM.

9. The computer-implemented method of claim 1, wherein:
obtaining the adaptation input based on the received particular trigger input comprises processing the particular trigger input to identify a particular fine-tuned user prompt embedding that maps to the particular trigger input, the particular fine-tuned user prompt embedding comprising the adaptation input; and
providing the adaptation input for input to the assistant LLM comprises;
concatenating the follow-on query with the particular fine-tuned user prompt embedding that maps to the particular trigger input; and
providing the concatenation of the follow-on query with the particular fine-tuned prompt embedding as input to the assistant LLM,
wherein, when processing the follow-on query to fulfill performance of the action specified by the natural language query, the particular fine-tuned user prompt embedding is configured to guide the assistant LLM to undertake the particular functionality while parameters of the assistant LLM are held fixed.

10. The computer-implemented method of claim 1, wherein:
obtaining the adaptation input based on the received particular trigger input comprises processing the particular trigger input to identify a particular natural language prefix prompt that maps to the particular trigger input, the particular natural language prefix prompt comprises the adaptation input; and
providing the adaptation input for input to the assistant LLM comprises;
concatenating the follow-on query with the particular natural language prefix prompt that maps to the particular trigger input; and
providing the concatenation of the follow-on query with the particular natural language prefix prompt as input to the assistant LLM,
wherein, when processing the follow-on query to fulfill performance of the action specified by the natural language query, the particular natural language prefix prompt is configured to instruct the assistant LLM to undertake the particular functionality.

11. The computer-implemented method of claim 1, wherein:
the assistant LLM comprises a pretrained assistant LLM having a set of pre-trained weights; and
obtaining the adaptation input based on the received particular trigger input comprises processing the particular trigger input to identify a particular set of one or more few-shot learning examples that maps to the particular trigger input, the particular set of one or more few-shot learning examples comprises the adaptation input, wherein each few-shot learning example in the particular set of the one or more few-shot learning examples depicts an example query input paired with a ground-truth response of the example query input to provide in-context learning for adapting the assistant LLM to generalize to the particular functionality specified by the trigger input.

12. The computer-implemented method of claim 1, wherein the operations further comprise, prior to commencing the processing of the follow-on query using the assistant LLM, commencing processing of the adaptation input to adapt the assistant LLM to undertake the particular functionality.

13. The computer-implemented method of claim 12, wherein commencing the processing of the adaptation input comprises performing vector index lookups to retrieve content relevant to the particular functionality specified by the particular trigger input for use by the assistant LLM once processing of the follow-on query commences, the retrieved content comprising at least one of:
one or more media files that were previously accessed by the assistant LLM to fulfill a previous query when the assistant LLM was adapted to undertake the same particular functionality;
one or more documents that were previously accessed by the assistant LLM to fulfill one or more previous queries when the assistant LLM was adapted to undertake the same particular functionality; or
one or more applications previously accessed by the assistant LLM to fulfill one or more previous queries when the assistant LLM was adapted to undertake the same particular functionality.

14. The computer-implemented method of claim 13, wherein the operations further comprise:
instructing an auxiliary LLM to preprocess the retrieved content; and
receiving, from the auxiliary LLM, preprocessed results for the retrieved content,
wherein commencing the processing of the adaptation input to adapt the assistant LLM to undertake the particular functionality comprises using the preprocessed results to adapt the assistant LLM to undertake the particular functionality.

15. The computer-implemented method of claim 12, wherein commencing the processing of the adaptation input comprises:
loading a user interface (UI) element that was previously generated by the assistant LLM when the assistant LLM was adapted to undertake the particular functionality during fulfillment of a previous query; and
displaying, on a screen in communication with the data processing hardware, the UI element,
wherein processing the follow-on query to fulfill performance of the action specified by the natural language query comprises interacting with the UI element displayed on the screen based on the action specified by the natural language query.

16. The computer-implemented method of claim 1, wherein:
the operations further comprise processing, using the assistant LLM, the adaptation input; and
the assistant LLM processes the adaptation input while receiving the follow-on query from the user.

17. The computer-implemented method of claim 1, wherein the operations further comprise:
based on processing the follow-on query to fulfill performance of the action, generating presentation content responsive to the follow-on query; and
based on the presentation content, obtaining another adaptation input specifically formulated for adapting the assistant LLM to undertake another particular functionality specified by a subsequent follow-on query.

18. A system comprising:
data processing hardware; and
memory hardware in communication with the data processing hardware, the memory hardware storing instructions that when executed on the data processing hardware cause the data processing hardware to perform operations comprising:
receiving, from a user, a particular trigger input directed toward an assistant large language model (LLM), the particular trigger input specifying a particular functionality for the assistant LLM to undertake for processing a follow-on query from the user;
based on the received particular trigger input, obtaining an adaptation input specifically formulated for adapting the assistant LLM to undertake the particular functionality specified by the particular trigger input;
receiving, from the user, the follow-on query, the follow-on query comprising a natural language query specifying an action for the assistant LLM to perform;
providing, for input to the assistant LLM, the adaptation input specifically formulated for adapting the assistant LLM to undertake the particular functionality specified by the particular trigger input; and
processing, using the adapted assistant LLM undertaking the particular functionality specified by the particular trigger input, the follow-on query to fulfill performance of the action specified by the natural language query.

19. The system of claim 18, wherein receiving the particular trigger input from the user comprises receiving a user input indication indicating selection of a particular user interface (UI) element displayed on a screen in communication with the data processing hardware.

20. The system of claim 19, wherein the particular UI element is one of at least two different UI elements displayed on the screen, each UI element of the at least two different UI elements specifying a different respective particular functionality for the assistant LLM to undertake.

21. The system of claim 18, wherein receiving the particular trigger input from the user comprises receiving a hotword detection event indication indicating detection of a particular hotword in streaming audio captured by a microphone in communication with the data processing hardware.

22. The system of claim 21, wherein the particular hotword is one of at least two different predetermined hotwords, each predetermined hotword of the at least two different predetermined hotwords specifying a different respective functionality for the assistant LLM to undertake.

23. The system of claim 18, wherein:
the assistant LLM comprises a pretrained assistant LLM having a set of pre-trained weights;
obtaining the adaptation input based on the received particular trigger input comprises processing the particular trigger input to identify a particular set of fine-tuned weights that map to the particular trigger input, the particular set of fine-tuned weights comprising the adaptation input and trained to adapt the assistant LLM model to undertake the particular functionality specified by the particular trigger input while the set of pretrained weights of the pretrained assistant LLM are frozen; and
providing the adaptation input for input to the assistant LLM comprises activating the particular set of fine-tuned weights for adapting the assistant LLM to undertake the particular functionality specified by the particular trigger input.

24. The system of claim 23, wherein the particular set of fine-tuned weights comprises one of multiple sets of fine-tuned weights, each corresponding set of fine-tuned weights of the multiple sets of fine-tuned weights:
maps to a different corresponding trigger input that specifies a different corresponding functionality for the pretrained assistant LLM to undertake; and
trained to adapt the pretrained assistant LLM to undertake the corresponding functionality specified by the corresponding trigger input while the set of pretrained weights of the pretrained assistant LLM are frozen.

25. The system of claim 23, wherein:
the pretrained assistant LLM comprises a plurality of multi-head attention layers; and
the particular set of fine-tuned weights are implemented by one or more adaptor layers each disposed within a respective one of the plurality of multi-head attention layers of the pretrained assistant LLM or between a respective pair of the plurality of multi-head attention layers of the pretrained assistant LLM.

26. The system of claim 18, wherein:
obtaining the adaptation input based on the received particular trigger input comprises processing the particular trigger input to identify a particular fine-tuned user prompt embedding that maps to the particular trigger input, the particular fine-tuned user prompt embedding comprising the adaptation input; and
providing the adaptation input for input to the assistant LLM comprises;
concatenating the follow-on query with the particular fine-tuned user prompt embedding that maps to the particular trigger input; and
providing the concatenation of the follow-on query with the particular fine-tuned prompt embedding as input to the assistant LLM,
wherein, when processing the follow-on query to fulfill performance of the action specified by the natural language query, the particular fine-tuned user prompt embedding is configured to guide the assistant LLM to undertake the particular functionality while parameters of the assistant LLM are held fixed.

27. The system of claim 18, wherein:
obtaining the adaptation input based on the received particular trigger input comprises processing the particular trigger input to identify a particular natural language prefix prompt that maps to the particular trigger input, the particular natural language prefix prompt comprises the adaptation input; and
providing the adaptation input for input to the assistant LLM comprises;
concatenating the follow-on query with the particular natural language prefix prompt that maps to the particular trigger input; and
providing the concatenation of the follow-on query with the particular natural language prefix prompt as input to the assistant LLM,
wherein, when processing the follow-on query to fulfill performance of the action specified by the natural language query, the particular natural language prefix prompt is configured to instruct the assistant LLM to undertake the particular functionality.

28. The system of claim 18, wherein:
the assistant LLM comprises a pretrained assistant LLM having a set of pre-trained weights; and
obtaining the adaptation input based on the received particular trigger input comprises processing the particular trigger input to identify a particular set of one or more few-shot learning examples that maps to the particular trigger input, the particular set of one or more few-shot learning examples comprises the adaptation input, wherein each few-shot learning example in the particular set of the one or more few-shot learning examples depicts an example query input paired with a ground-truth response of the example query input to provide in-context learning for adapting the assistant LLM to generalize to the particular functionality specified by the trigger input.

29. The system of claim 18, wherein the operations further comprise, prior to commencing the processing of the follow-on query using the assistant LLM, commencing processing of the adaptation input to adapt the assistant LLM to undertake the particular functionality.

30. The system of claim 29, wherein commencing the processing of the adaptation input comprises performing vector index lookups to retrieve content relevant to the particular functionality specified by the particular trigger input for use by the assistant LLM once processing of the follow-on query commences, the retrieved content comprising at least one of:
one or more media files that were previously accessed by the assistant LLM to fulfill a previous query when the assistant LLM was adapted to undertake the same particular functionality;
one or more documents that were previously accessed by the assistant LLM to fulfill one or more previous queries when the assistant LLM was adapted to undertake the same particular functionality; or
one or more applications previously accessed by the assistant LLM to fulfill one or more previous queries when the assistant LLM was adapted to undertake the same particular functionality.

31. The system of claim 30, wherein the operations further comprise:
instructing an auxiliary LLM to preprocess the retrieved content, and
receiving, from the auxiliary LLM, preprocessed results for the retrieved content,
wherein commencing the processing of the adaptation input to adapt the assistant LLM to undertake the particular functionality comprises using the preprocessed results to adapt the assistant LLM to undertake the particular functionality.

32. The system of claim 29, wherein commencing the processing of the adaptation input comprises:
loading a user interface (UI) element that was previously generated by the assistant LLM when the assistant LLM was adapted to undertake the particular functionality during fulfillment of a previous query; and
displaying, on a screen in communication with the data processing hardware, the UI element,
wherein processing the follow-on query to fulfill performance of the action specified by the natural language query comprises interacting with the UI element displayed on the screen based on the action specified by the natural language query.

33. The system of claim 18, wherein:
the operations further comprise processing, using the assistant LLM, the adaptation input; and
the assistant LLM processes the adaptation input while receiving the follow-on query from the user.

34. The system of claim 18, wherein the operations further comprise:
based on processing the follow-on query to fulfill performance of the action, generating presentation content responsive to the follow-on query; and
based on the presentation content, obtaining another adaptation input specifically formulated for adapting the assistant LLM to undertake another particular functionality specified by a subsequent follow-on query.
